(19) United States
(12) Patent Application Publication
(10) Pub. No.: US 2017/0335178 A1
(43) Pub. Date: Nov. 23, 2017

(54) SALT-TOLERANT SELF-SUSPENDING PROPPANTS

(71) Applicant: Self-Suspending LLC, Chesterland, OH (US)

(72) Inventors: Moustafa Aboushabana, Stafford, TX (US); Huaxiang Yang, Sugar Land, TX (US); Kanth Josyula, Sugar Land, TX (US); Vinay Mehta, Richmond, TX (US)

(21) Appl. No.: 15/595,722

(22) Filed: May 15, 2017

Related U.S. Application Data
(60) Provisional application No. 62/337,547, filed on May 17, 2016.

(51) Int. Cl. C09K 8/80; C09K 8/90; C09K 8/84; C09K 8/70; C09K 8/03; E21B 43/267; C09K 8/02

(52) U.S. Cl. CPC C09K 8/805; E21B 43/267; C09K 8/90; C09K 8/02; C09K 8/70; C09K 8/03; C09K 8/845

(57) ABSTRACT

A self-suspending proppant that resists the adverse effects of calcium and other cations on swelling comprises a proppant substrate particle and a gelatinized cationic starch coating on the proppant substrate particle.

### CROSS-REFERENCE TO RELATED APPLICATION

This application claims priority to and all benefit of U.S. Provisional Patent Application Ser. No. 62/337,547, filed on May 17, 2016, titled SALT-TOLERANT SELF-SUSPENDING PROPPANTS, the entire disclosure of which is fully incorporated herein by reference.

### BACKGROUND

In commonly assigned U.S. Pat. No. 9,297,244 (7-US) and U.S. Pat. No. 9,315,721 (4-US), there are described self-suspending proppants which take the form of a proppant substrate particle carrying a coating of a hydrogel-forming polymer. As further described there, these proppants are formulated in such a way that they rapidly swell when contacted with aqueous fracturing fluids to form hydrogel coatings which are large enough to significantly increase the buoyancy of these proppants during their transport downhole yet durable enough to remain largely intact until they reach their ultimate use locations. The disclosures of all of these earlier applications are incorporated herein by reference in their entireties.

It is well known that calcium and other cations can substantially retard the ability of anionic hydrogel-forming polymers to swell. In this context, an “anionic hydrogel-forming polymer” will be understood to mean a hydrogel-forming polymer whose hydrogel-forming properties are primarily due to pendant carboxylate groups but may also be due to other anionic groups such as sulfonate, phosphonate, sulfate and phosphate groups. This problem can be particularly troublesome when such polymers are used in hydraulic fracturing applications, because the source water used to make up the associated fracturing fluids, as well as the geological formation water encountered downhole, often contain significant quantities of these ions.

### SUMMARY

In accordance with this invention, we have found that self-suspending proppants which are both durable and especially resistant to the adverse effects of calcium and other cations on swelling can be obtained by (1) selecting a cationic starch as the hydrogel-forming polymer, (2) chemically modifying the cationic starch, the proppant substrate particles or both to enhance coating adhesion, (3) mixing the cationic starch with the proppant substrate particles while the starch is at least partially gelatinized thereby forming discrete starch-coated substrate particles, and then (4) drying the starch-coated substrate particles so formed.

Thus, this invention provides a self-suspending proppant which is both durable and especially resistant to the adverse effects of calcium and other cations on swelling, this self-suspending proppant comprising a proppant substrate particle and a gelatinized cationic starch coating on the proppant substrate particle.

In addition, this invention also provides a process for making a self-suspending proppant that is both durable and especially resistant to the adverse effects of calcium and other cations on swelling, the self-suspending proppant comprising a proppant substrate particle and a cationic starch coating on the proppant substrate particle, the process comprising chemically modifying the cationic starch, the proppant substrate particles or both to enhance coating adhesion, mixing the cationic starch with the proppant substrate particles while the starch is at least partially gelatinized thereby forming discrete starch-coated substrate particles, and then drying the starch-coated substrate particles so formed.

In addition, this invention also provides an aqueous fracturing fluid comprising an aqueous carrier liquid containing the above self-suspending proppant.

In addition, this invention further provides a method for fracturing a geological formation comprising pumping this fracturing fluid into the formation.

### DETAILED DESCRIPTION

### Proppant Substrate Particle

As indicated above, the inventive self-suspending proppants take the form of a proppant substrate particle carrying a coating of a cationic polymer.

For this purpose, any particulate solid which has previously been used or may be used in the future as a proppant in connection with the recovery of oil, natural gas and/or natural gas liquids from geological formations can be used as the proppant substrate particle of the inventive self-suspending proppants. In this regard, see our earlier filed applications mentioned above which identify many different particulate materials which can be used for this purpose. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, resin coated sand including sands coated with curable resins as well as sands coated with precured resins, bauxite, ceramic materials, resin coated ceramic materials including ceramics coated with curable resins as well as ceramic coated with precured resins, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities 1.8-2.0 g/cc), normal frac sand (density ˜2.65 g/cc), bauxite and high density ceramics (density ˜3-5 g/cc), just to name a few. Resin-coated versions of these proppants, and in particular resin-coated conventional frac sand, are also good examples.

All of these particulate materials, as well as any other particulate material which is used as a proppant in the future, can be used as the proppant substrate particle in making the inventive self-suspending proppants.

### Hydrogel Coating

As indicated above, the inventive self-suspending proppants are made in such a way that
(1) optionally and preferably, they are free-flowing when dry,
(2) they rapidly swell when contacted with their aqueous fracturing fluids,
(3) they form hydrogel coatings which are large enough to significantly increase their buoyancy during transport downhole, thereby making these proppants self-suspending during this period,
(4) these hydrogel coatings are durable enough to maintain the self-suspending character of these proppants until they reach their ultimate use locations downhole, and
(5) these hydrogel coatings are especially resistant to the adverse effects calcium and other cations can have on the swelling properties of these coatings.

In accordance with this invention, this is accomplished by (1) selecting a cationic starch as the hydrogel-forming polymer, (2) chemically modifying the cationic starch, the proppant substrate particles or both to enhance coating adhesion, (3) mixing the cationic starch with the proppant substrate particles while the starch is at least partially gelatinized thereby forming discrete starch-coated substrate particles, and then (4) drying the starch-coated substrate particles so formed.

A wide variety of different starches can be used as raw materials for making the inventive self-suspending proppants. Examples include naturally-occurring starches, modified starches (cationic, anionic and amphoteric), acid-modified starches, alkylated starches, oxidized starches, acetylated starches, hydroxypropylated starches, monophosphorylated starches, octenylscuccinylated starches and so forth. Any such starch can be used for the purposes of this invention, provided that it is in a cationic form as further discussed below.

Starches can be anionic, cationic and amphoteric, depending primarily on the nature of the substituents present at the 2, 3, 5 and 6 positions of the monosaccharide units forming the starch molecule. In accordance with this invention, the starches that are used to make the hydrogel coatings of the inventive self-suspending proppants are cationic starches. Especially interesting are those having degrees of substitution (i.e., cationic degree of substitution) of 0.017 to 0.55 or higher, more typically 0.030 to 0.55, 0.15 to 0.45 or even 0.2 to 0.4. Of these cationic starches, those having from about 1 to 50 wt. %, more typically about 5 to 30 wt. % or even about 10 to 25 wt. % of amylose (linear polymer) units and about 50 to 99 wt. %, more typically about 70 to 95 wt. % or even about 75 to 90 wt. % of amylopectin (branched polymer) are even more interesting. Also especially interesting are those cationic starches whose cationic functionality is based on quaternary ammonium groups.

The cationic starches which are useful in this invention typically have molecular weights of about 1 to 8 million Daltons, more typically about 2 to 6 million Daltons, although higher and lower molecular weights are still possible.

Those of the above cationic starches having both a high degree of substitution as represented by a degree of substitution of at least about 0.04, preferably at least about 0.1, and a low amylose content, i.e., 10 wt. % or lower, are especially interesting.

A wide variety of different commercially available cationic starches can be used for the purposes of this invention. Examples include the ALTRA-CHARGE line of cationic starches available from Cargill, Incorporated of Wayzata, Minn., the STA-LOK and INTERBOND line of cationic starches available from Tate & Lyle of Decatur, Ill., and the CHARGEMASTER line of cationic starches available from Grain Processing Corporation of Muscatine, Iowa. They are available in different forms including powders, aqueous pastes, aqueous slurries and aqueous solutions. All of these different forms of cationic starches can be used to make the self-suspending proppants of this invention.

Specific examples of cationic starches in powder form that can be used for this purpose include CHARGEMASTER R31F, R32F, R33F, R43F, R25F, R67F, R467, R62F, R63F and R65F, Interbond® C, tSta-Lok® 120, 156, 160, 180, 182, 190, 300, 310, 330, 356 and 376, and Altra Charge™ 240 and 340 and others. Specific examples of cationic starches in paste or slurry form that can be used for this purpose include CHARGEMASTER L435, L340 and L360.

In addition to purchasing commercially available cationic starches, these materials can also be made in-house if desired. For example, a starch can be made cationic by reacting it with any known cationic reagent, examples of which include reagents having amino groups, imino groups, sulfonium ions, phosphonium ions, or ammonium ions and mixtures thereof. The cationization reaction may be carried out in any conventional manner such as reacting the starch with the cationic reagent in an aqueous slurry, usually in the presence of an activating agent such as a base like sodium hydroxide. Another process that may be used is a semi-dry process in which the starch is reacted with the cationic reagent in the presence of an activating agent such as a base like sodium hydroxide in a limited amount of water.

Especially interesting cationic reagents that can be used for this purpose are those based on quaternary ammonium compounds in either epoxy or chlorohydrin form. This is because the epoxy and chlorohydrin functionalities of these compounds react quickly with the pendant alcohol groups of the sachharide units while their quaternary ammonium groups provide the cationic functionality to the polymer. Specific examples include (3-chloro-2-hydroxypropyl)trimethylammonium chloride and 2,3-epoxypropyltrimethylammonium chloride.

Techniques for preparing cationic starches are well known and described in numerous references. See, for example, U.S. Pat. No. 4,554,021. See, also, QUAB® Cationization of Polymer, Product literature of SKW Quab Chemicals, Inc. of Saddle Brook, N.J., pp 1-11. Also, see, Moad, Chemical Modification of Starch by Reactive Extrusion, Progress in Polymer Science 36 (2011) 218-237. In addition, please also note Properties of Modified Starches and their Use in the Surface Treatment of Paper, Dissertation of Anna Jonhed, 2006:42, at http://www.diva-portal.org/smash/get/diva2:6450/FULLTEXT01.pdfAnna, Karlstad University 2006. The disclosures of each of these references are incorporated herein by reference in their entireties.

In addition to using the above cationic starches, copolymers of these cationic starches with other vinyl comonomers can also be used to make the inventive self-suspending proppants. Examples of such comonomers include acrylamides, acrylates, methacrylates, 2-acrylamido-2-methylpropanesulfonic acid (AMPS), vinyl acetate, vinyl alcohol and so forth. Desirably, these cationic starch copolymers have the same degree of substitution mentioned above. That is, the degree of substitution provided by the cationic functionality of these copolymers is the same as mentioned above.

In addition to the above cationic starches and starch copolymers, blends of these starches and starch copolymers with other cationic hydrogel-forming polymers can also be used. For example, cationic polysaccharides other than cationic starches can be used. Examples include chitosan, cellulose, and cellulose derivatives including alkyl cellulose ethers such as methyl cellulose, ethyl cellulose and/or propyl cellulose, hydroxy cellulose ethers such as hydroxy methyl cellulose, hydroxy ethyl cellulose and/or hydroxy propyl cellulose, cellulose esters such as cellulose acetate, cellulose triacetate, cellulose propionate and/or cellulose butyrate, cellulose nitrate, cellulose sulfate and glycogen. Mixtures of these cationic polysaccharides other than cationic starches can also be used.

Another type of cationic hydrogel-forming polymer that can also be used is the cationic polyacrylamides. These polymers are copolymers of acrylamide and one or more additional comonomers capable of introducing cationic functionality into the polymer. They also may be chemically modified polyacrylamides made by introducing one or more cationic moieties. This cationic functionality can be based on a variety of different pendant cationic groups including quaternary ammonium compounds, phosphonium salts and sulphonium salts. Such cationic polyacrylamides typically have weight average molecular weights on the order of 100,000 to 60,000,000 Daltons, more typically, 500,000 to 40,000,000 Daltons or even 10,000,000 to 30,000,000 Daltons, and charge densities of 5 to 85 mole %, more typically, 10 to 80 mole % or even 15 to 70 mole %.

An example of such a cationic polyacrylamide is given by the following formula:

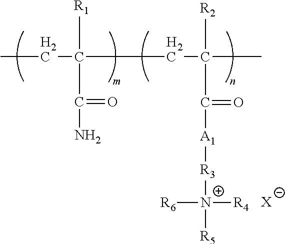

wherein
m is the molar fraction of acrylamide or methacrylamide in the copolymer,
n is the molar fraction of cationic comonomer in the copolymer,
m and n are each independently within the range of from 0 to 1,
(m+n)≦1,
R₁ is hydrogen or methyl,
R₂ is hydrogen or methyl,
A₁ is —O— or —NH—,
R₃ is alkylene having from 1 to 3 carbon atoms or hydroxypropylene,
R₄, R₅ and R₆ are each independently methyl or ethyl or other alkyl having from 3 to 12 carbon atoms, and
X is an anionic counter ion, such as, for example, chloride, bromide, methyl sulfate, ethyl sulfate or the like.
   Note that, when A₁ is —NH—, it can be considered as chemically modified polyacrylamide rather than a copolymer theoretically.

In a particular polyacrylamide of this type, the molar ratio of acrylamide (m) to cationic monomer (n) is in the range of 0:1 to 0.95:0.05, while the sum of the molar ratios of m and n is 1.

The cationic polyacrylamides of the above formula can be random or block copolymers.

Still other types of cationic hydrogel-forming polymers that can be used include other biopolymers, e.g., proteins, protein hydrolysates, gelatins and the like, which have been cationized in the manner indicated above.

In those instances in which cationic hydrogel-forming polymers other than cationic starches and starch copolymers are used, at least 50 wt. % of the hydrogel-forming material used, as a whole, should be based on monosaccharide units. Blends in which the amount of polymerized monosaccharide units is at least 60 wt. %, at least 70 wt. %, at least 80 wt. % and even at least 90 wt. % are also contemplated.

### Gelatinizing the Starch

In accordance with this invention, the proppant substrate particles and the cationic starch are mixed together while the starch is at least partially gelatinized in form.

Starch molecules arrange themselves in plants in semi-crystalline granules. Heating in water causes water molecules to diffuse through these granules, causing them to become progressively hydrated and swell. In addition, their amylose content depletes through leaching out by the water. When further heated, these granules “melt” or “destructure” in the sense that their semi-crystalline structure is lost, which can be detected by a variety of different means including X-ray scattering, light-scattering, optical microscopy (birefringence using crossed polarizers), thermomechanical analysis and NMR spectroscopy, for example. This “melting”-“destructuration” effect is known as gelatinization. See, Kalia & Averous, Biopolymers: Biomedical and Environmental Applications, p. 89, © 2011 by Scrivener Publishing LLC, Co-published by John Wiley & Sons, Hoboken, N.J. In accordance with this invention, the cationic starch is at least partially gelatinized when it is being mixed with the proppant substrate particles.

In this regard, it is well known that the amount of water that can be taken up by starch when it gels can be many times its weight, e.g., as much as 80 times its weight. So, when we say that the cationic starch is “at least partially gelatinized,” what we mean is that the amount of water that has been taken up by the starch through gelatinization may be less than the total amount of water the cationic starch is capable of taking up through gelatinization. Indeed, in most instance of our invention, the amount of water that has been taken up by the starch through gelatinization will be less than this total. However, if desired, enough water can be used so that the maximum possible amount of water for gelatinization has been taken up by the starch.

Also, for convenience, we use the term “gelatinized starch” in this disclosure to refer both to starches which are only partially gelatinized as well as to starches which are fully gelatinized in the sense of being incapable of taking up any more water of gelatinization. Where we intend to refer to fully gelatinized starches, we use that term, i.e., “fully gelatinized starch.”

A convenient way of insuring that the desired degree of starch gelatinization is achieved is to control the water/cationic starch weight ratio of the water/starch combination. Normally, this ratio can range from about 0.05:1 to 15:1, although water/starch weight ratios of 0.5:1 to 10:1, 0.75:1 to 7.5:1, 1:1 to 5:1, 1.25:1 to 4:1, and even 1.5:1 to 3:1, are contemplated. And for this calculation, it will be understood that all of the water supplied to the starch/proppant substrate particle mixture will be taken into account including the moisture content of the cationic starch, the water content of the cationic starch paste, emulsion and/or solution if the starch is supplied in one of these forms, any make-up water that might be added, and the water content of any additives that might be used such as crosslinking agents and pretreating agents for the proppant substrate particles. In addition, if a hydrogel-forming polymer other than a cationic starch is included in the system, it will be understood that the above water/cationic starch weight ratios will be based on all of the hydrogel-forming polymer in the system, not just the cationic starch.

Also, in some embodiments of this invention, as further discussed below, it may be desirable to cause the mixture of proppant substrate particles and gelatinized cationic starch to adopt a highly viscous consistency. For this purpose, it may be desirable to limit the amount of make-up water added to this mixture, if any, such that the water/starch ratio of the mixture is 4 or less, 3 or less, 2 or less, 1 or less, or even 0.5 or less.

As indicated above, the cationic starch raw material that is used to carry out the inventive process, as received from the manufacturer, can be in a variety of different forms including a thick paste or slurry in which the starch has already been gelatinized as well as a solution, emulsion or dispersion of ungelatinized starch containing enough water for gelatinization. In these instances, adding additional make-up water for gelatinization may be unnecessary. In other instances, the cationic starch raw material as received from the manufacturer may contain little or no water such as occurs, for example, when it is in the form of an ungelatinized powder. If so, an appropriate amount of make-up water will normally be added. It will therefore be appreciated that the amount of make-up water which is added to insure that the cationic starch is at least partially gelatinized when mixed with the proppant substrate particles will depend among other things on the nature of the cationic starch that is used to make this mixture.

Starch gelatinization normally requires that the starch-water combination have a slightly alkaline pH such as ≧7.5, ≧8, ≧9, and even ≧10. Any such pH can be used for carrying out this invention. In addition, while NaOH is most conveniently used for pH adjustment, other chemicals can also be used. In lieu of pH adjustment, other means for facilitating starch gelatinization can also be used, examples of which include enzymatic action and physical means. See, Maher, Alkali Gelatinization of Starches, Starch/Starke 35 (1983) Nr. 7, S. 226-234, © Verlag Chemie GmbH, D-6940 Weinheim 1983.

In addition to sufficient water at a suitable pH, starch gelatinization also normally requires that the starch-water combination be heated to above a characteristic temperature, known as the gelatinization temperature. See, the above-noted Kalia publication. Note, also, that this temperature can be lowered by the use of additional materials such as such as alcohols, sugars, organic acids, etc., which can be used in this invention, if desired. So, in carrying out this invention, heating of the cationic starch under suitable conditions to achieve at least partial starch gelatinization may be necessary, depending on the nature of the raw material starch that is being used.

For example, in those instances in which the cationic starch raw material is in the form of a thick paste or slurry in which the starch has already been gelatinized, little or no heating for effecting starch gelatinization may be necessary. On the other hand, in those instances in which the cationic starch raw material is in the form of an aqueous solution, emulsion or dispersion of ungelatinized starch or an ungelatinized starch powder, heating under appropriate conditions for effecting starch gelatinization may be necessary. It will therefore be appreciated that the amount of heating needed to effect starch gelatinization will also depend among other things on the nature of the cationic starch raw material that is used to make this mixture.

Where heating is needed for starch gelatinization, this will normally be done at moderate temperatures, e.g., 40°-100° C., although gelatinization temperatures of 45°-90° C., 50°-80° C. or even 60°-75° C., are also contemplated. As shown in the following working examples, heating under these conditions will normally be sufficient to cause the desired starch gelatinization to occur in a relatively short period of time, e.g., 30 minutes or less.

Still another way of achieving starch gelatinization is to use a heated extruder or other similar heated mixing device. In this context, a “heated extruder” will be understood to mean an extruder in which heat is supplied to the raw materials being processed by the extruder, regardless of whether the heat is supplied by the extruder itself or whether heat is supplied by heating the ingredients being processed before they are introduced into the extruder. Using heated extruders for starch gelatinization is well-known technology which has been used in the food industry for many years. See, for example, Harper, J. M. (1978). “Food extrusion”. Critical Reviews in Food Science and Nutrition 11 (2): 155-215. doi:10.1080/10408397909527262. PMID 378548. See, also, Riaz, Mian N. (2000). Extruders in Food Applications. CRC Press. p. 193. ISBN 9781566767798, as well as Akdogan, Hülya (June 1999). “High moisture food extrusion”. International Journal of food Science & Technology 34 (3): 195-207. doi:10.1046/j.1365-2621.1999.00256.x. An advantage of this approach is that, not only is this technology already well-known, but in addition less water can be used to accomplish starch gelatinization than when other types of mixing equipment are used.

For example, when a heated extruder is used, the amount of water needed to achieve starch gelatinization can be as low as 5 wt. % or even lower based on the weight of the cationic starch. In other words, the water/cationic starch weight ratio can be as low as 0.05:1 or even lower. The practical effect of this more limited amount of water as it relates to this invention is that less time, effort and expense is involved in drying the starch/proppant substrate particle mixture into free-flowing proppant as compared with using other types of equipment and approaches. Thus, it is contemplated that, when this approach is used, the water/cationic starch weight ratio will normally be 0.5:1 or less, more typically 0.3:1 or less, 0.2:1 or less, 0.1:1 or less or even 0.05:1 or less.

As indicated in the above-mentioned publications, one advantage of using a heated extruder or similar mixing device for starch gelatinization is that cationization of the starch can be done at the same time by including the cationic reagent needed for starch cationization in the ingredients being charged into the extruder. This approach can be taken advantage of in this invention by charging all the ingredients needed for starch gelatinization and cationization, i.e., the raw material starch, water for gelatinization preferably at an alkaline pH, and the cationic reagent needed for starch cationization, into the continuously operating heated extruder or the like and recovering the gelatinized, cationic starch produced thereby as the extruder extrudate for mixing with the proppant substrate particles. While any cationic reagent can be used for this purpose, as indicated above, those based on quaternary ammonium compounds in either epoxy or chlorohydrin form are preferred, while (3-chloro-2-hydroxypropyl)trimethyl ammonium chloride and 2,3-epoxypropyltrimethyl ammonium chloride are especially preferred.

### Mixing the Starch and Proppant Substrate Particles

As indicated above, the proppant substrate particles and the cationic starch are mixed together while the starch is at least partially gelatinized in form. For this purpose, these ingredients can be combined with one another before, during or after starch gelatinization. So, for example, if the cationic starch raw material being used is an ungelatinized powder, the proppant substrate particles, the starch powder and make-up water can be combined with one another before starch gelatinization. Continued heating and mixing will cause the starch to gelatinize and swell, thereby thickening the mixture, followed by coating of the proppant substrate particles with the gelatinized starch.

Alternatively, the starch can be heated for gelatinization before being combined with the proppant substrate particles followed by mixing for coating the gelatinized starch onto the proppant substrate particles. If so, desirably, the gelatinized starch is directly combined with the proppant substrate particles as soon as it is formed. In this context, “directly combined” means that the gelatinized starch is combined with the proppant substrate particles without allowing the starch to dry or to cool to room temperature. Preferably, combining the starch with the proppant substrate particles occurs within 30 minutes of the time when gelatinization of the cationic starch has been completed.

In the same way, if the cationic starch raw material being used is an aqueous solution, emulsion or dispersion of ungelatinized starch, it can be combined with the proppant substrate particles before the starch is gelatinized, in which case continued heating and mixing will cause starch gelatinization to occur followed by starch coating. Alternatively, the starch can be gelatinized first, after which the gelatinized starch so formed is preferably directly combined with the proppant substrate particles, followed by mixing for starch coating.

In contrast, if raw material cationic starch is already gelatinized, the starch and proppant particles, of course, will be combined after starch gelatinization has already occurred. In this case, mixing is carried out to effect coating the gelatinized starch onto the proppant substrate particles.

As indicated above, the proppant substrate particles and the gelatinized starch are mixed together in such a way that a mass of individual, discrete starch-coated proppant particles is formed. A convenient way this can be done is by formulating this mixture so that, when starch gelatinization is completed, this mixture is highly viscous in nature. By “highly viscous” we mean that the starch (plus any other hydrogel-forming polymers that may be present, if any) in this mixture has a viscosity of at least 2,000 cPs. Viscosities of at least 3,500 cPs, at least 4,000 cPs, at least 5,000 cPs, at least 7,500 cPs, and even at least 10,000 cPs are also of interest. Because of this viscosity, simple mixing causes the starch to form uniform, continuous coatings on the individual proppant substrate particles. In addition, it also causes the coated particles so formed to separate from one another into individual, discrete starch-coated particles that retain their individual, discrete nature even after mixing has stopped.

As indicated above, achieving this “highly viscous” nature can most easily be done formulating the mixture of proppant substrate particles and gelatinized starch so that its water/starch ration is 4 or less, more typically 3 or less, 2 or less, 1 or less, or even 0.5 or less. In these situations, heating the mixture to moderate temperatures (e.g., 80° C. or below) as described above, with simple continuous mixing, will normally be sufficient to cause the viscosity of the starch to increase to the desired level and hence the desired starch coating to form in a relatively short period of time, e.g., 30 minutes or less, as illustrated in the following working examples.

Another way of forming a highly viscous mixture of the gelatinized starched and proppant substrate particles is to produce the gelatinized starch in a heated extruder or other similar heated mixing device, directly combine the gelatinized starch so formed with the proppants substrate particles, and then mix the resulting mixture until starch-coated proppant substrate particles are obtained. In this context, “directly combine” has the same meaning as above.

The relative amounts of cationic starch and proppant substrate particles to use in making the inventive self-suspending proppants depends among other things on the degree or extent to which it is desired to increase the buoyancy of the self-suspending proppants being made. One way this enhanced buoyancy can be quantified is by comparing the thickness of the hydrogel coating that is formed after the cationic starch coating has expanded through contact with an excess of water with the average diameter of the proppant particle substrate.

Another way this enhanced buoyancy can be quantified is by determining the settled bed height of the self-suspending proppant after its cationic starch coating has expanded through contact with an excess of water with the settled bed height of an equivalent amount of uncoated proppant substrate particles.

Still another way this enhanced buoyancy can be quantified is by comparing the density of the inventive self-suspending proppant when fully hydrated to the density of the proppant substrate particle from which it is made. For example, normal frac sand has a density of ˜2.65 g/cc, whereas a self-suspending proppant made from this substrate particle can have a density of 1.5 g/cc when fully hydrated, for example. This means that the hydrogel coating has been able to decrease the effective density of this self-suspending proppant by 1.15 g/cc.

In carrying out this invention, the relative amounts of cationic starch and proppant substrate particles used can vary widely, and essentially any amounts can be used. In some embodiments, the amount used will be sufficient so that the thickness of the hydrogel coating which is formed upon gelatinization is 10% to 1000% of the average diameter of the proppant particle substrate. Hydrogel coating thicknesses of 25% to 750%, 50% to 500% and 100% to 300% of the average diameter of the proppant particle substrate are contemplated.

In other embodiments, the amount of cationic starch used will be sufficient so that the settled bed height, as determined in the manner discussed more fully below, is at least 150%, more desirably, at least 175%, at least 200%, at least 250%, at least 300%, at least 350% and even at least 400% of the settled bed height of an equivalent amount of uncoated proppant substrate particles.

In yet other embodiments, the amount of cationic starch used will be sufficient so that a decrease in density of at least about 0.25 g/cc, determined as described above, is achieved. More typically, the decrease in density will be at least about 0.50 g/cc, at least about 0.75 g/cc, at least about 1.00 g/cc, at least about 1.25 g/cc, or even at least about 1.50 g/cc.

Meanwhile, the maximum amount of cationic starch that can be used will normally be limited by practical considerations in the sense that this amount is desirably not so much that no practical advantage is realized in terms of the increase in buoyancy provided by this material. This can be easily determined by routine experimentation.

So, for example, in embodiments of this invention in which normal frac sand (density ˜2.65 g/cc) is used as the proppant substrate particle, the amount of cationic starch used on a dry weight basis will normally be about 0.5 to 80 wt. %, more typically 1 to 50 wt. %, 2 to 40 wt. %, 3 to 25 wt. %, more typically, about 5-20 wt. %, about 6-15 wt. %, about 7-12 wt. % or even 8-10 wt. % based on the weight of the frac sand used. When other proppant substrate particles are used, comparable amounts of cationic starch can be used. So, for example, if an intermediate density ceramic having a density of about 1.9 g/cc is used, the amount of cationic starch used on a dry weight basis can be about 0.72 (1.9/2.65) times the above amounts on a dry weight basis if the same relative increase in buoyancy is desired. If a greater amount of buoyancy is desired, more cationic starch can be used, while if a less amount of buoyancy is desired, less cationic starch can be used, all of which can be easily determined by routine experimentation.

### Chemical Modification for Enhancing Coating Adhesion

In order to improve the durability of the cationic starch coating of the inventive self-suspending proppants once it has swollen from contact with its aqueous hydraulic fracturing fluid, the cationic starch forming the coating, the proppant substrate particle, or both are chemically treated by one or more adhesion-promoting approaches.

In accordance with one such approach, the cationic starch is crosslinked. For this purpose any di- or polyfunctional crosslinking agent having two or more functional groups capable of reacting with the pendant hydroxyl, hydroxymethyl or other electronegative groups of the cationic starch can be used. For example, organic compounds containing and/or capable of generating at least two of the following functional groups can be used: epoxy, carboxy, aldehyde, isocyanate, amide, vinyl, and allyl. Polyfunctional inorganic compounds such as borates, zirconates, silicas and their derivatives can also be used as can guar and its derivatives.

Specific examples of polyfunctional crosslinking agents that can be used in this invention include epichlorohydrin, polycarboxylic acids, carboxylic acid anhydrides such as maleic anhydride, carbodiamide, formaldehyde, glyoxal, glutaraldehyde, various diglycidyl ethers such as polypropylene glycol diglycidyl ether and ethylene glycol diglycidyl ether, other di-or polyfunctional epoxy compounds, phosphorous oxychloride, sodium trimetaphosphate and various di-or polyfunctional isocyanates such as toluene diisocyanate, methylene diphenyl diisocyanate, 1-ethyl-3-(3-dimethylaminopropyl) carbodiamide, methylene bis acrylamide, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

The amount of such crosslinking agents that can be used can vary widely, and essentially any amount can be used. Normally, however, the amount used will be about 1 to 50 wt. %, more typically about 1 to 40 wt. %, about 3 to 40 wt. %, about 3 to 25 wt. %, about 5 to 40 wt. %, about 5 to 25 wt. %, or even about 5 to 12 wt. %, based on the dry weight of the cationic starch that is being used.

If a crosslinking agent is used, it can be added to the other ingredients at any time during preparation of the inventive self-suspending proppant. For example, it can be added as an additional ingredient to the mixture of cationic starch and proppant substrate particles, before, after or simultaneously with gelatinization. In addition, it can also be added to the proppant particle substrate particles, or the cationic starch, or both, before they are combined with one another. In addition, it can also be added to the starch coated proppant particles after they have formed during the final drying and comminution step, thereby forming an outer crosslinked layer on the hydrogel polymer coating.

When a crosslinking agent is used, a catalyst for the crosslinking agent can also be included, if desired. Examples of suitable catalysts include acids, bases, amines and their derivatives, imidazoles, amides, anhydrides, and the like. These catalyst can be added together with the crosslinking agent or separately. If added separately, they can be added at any time during the preparation of the inventive self-suspending proppant, in the same way as the catalyst, as described above.

Another adhesion-promoting approach that can be used is pretreating the proppant substrate particles with a suitable adhesion promoter. For example, the proppant substrate particles can be pretreated with a silane coupling agent before it is combined with the cationic starch. The chemistry of silane coupling agents is highly developed, and those skilled in the art should have no difficulty in choosing particular silane coupling agents for use in particular embodiments of this invention.

If desired, the silane coupling agent can be a reactive silane coupling agent. As well understood in the art, reactive silane coupling agents contain a functional group capable of reacting with functional groups on the polymers to be coupled. In this invention, therefore, the particular reactive silane coupling agents used desirably contain functional groups capable of reacting with the pendant hydroxyl, hydroxy methyl or other electronegative groups of the cationic starch. Examples of such reactive silane coupling agents include vinyl silanes such as vinyl trimethoxy silanes, vinyl ethoxy silanes and other vinyl alkoxy silanes in which the alkyl group independently have from 1 to 6 carbon atoms. Other examples include reactive silane coupling agents which are based on one or more of the following reactive groups: epoxy, glycidyl/epoxy, allyl, and alkenyl.

Another type of adhesion promoter that can be used include agents which provide a wetting/binding effect on the bond between the proppant substrate particle and the cationic starch coating. Examples include reactive diluents, wax, water, surfactants, polyols such as glycerol, ethylene glycol and propylene glycol, various tackifiers such as waxes, glues, polyvinyl acetate, ethylene vinyl acetate, ethylene methacrylate, low density polyethylenes, maleic anhydride grafted polyolefins, polyacrylamide and its blends/copolymerized derivatives, and naturally occurring materials such as sugar syrups, gelatin, and the like. Nonionic surfactants, especially ethoxylated nonionic surfactants such as octylphenol ethoxylate, are especially interesting.

Still another type of adhesion promoter that can be used is the starch crosslinking agents mentioned above. In other words, one way these crosslinking agents can be used is by pretreating the proppant substrate particles with them before these particles are mixed with the cationic starch.

### Drying

In accordance with this invention, the mixture of proppant substrate particles and gelatinized cationic starch as described above is dried to produce a mass of free-flowing self-suspending proppants. Drying can be done without application of heat, if desired. Normally, however, drying will be done by heating the mixture at temperatures as low as 40° C. and high as 300° C., for example. Normally, however, drying will be done at temperatures above the boiling point of water such as, for example, at >100° C. to 300° C., >100° C. to 200° C., 105° C. to 150° C., 110° C. to 140° C. or even 115° C. to 125° C. Also, in those embodiments in which the starch is heated for gelatinization in an earlier process step, as described above, drying will normally be done at drying temperatures which are higher than the gelatinization temperature by at least 20° C., more typically at least 30° C., at least 40° C., or even at least 50° C.

In some embodiments of this invention in which a crosslinking agent for the cationic starch is included in the system, the temperatures used for starch gelatinization in the mixing step described above may not be high enough to trigger the desired crosslinking reaction in any significant way. If so, the temperature at which drying of the coated proppants is carried out is preferably carried out at temperatures which are high enough to cause this crosslinking reaction to occur in a reasonable amount of time. So, for example, if an epoxy-based crosslinking agent such as polypropylene glycol diglycidyl ether is used, drying temperatures of 110° C., 120° C. or more are preferably used as they will cause crosslinking to occur within 30 minutes or so, as shown in the following working examples.

In addition, in carrying out this drying step, although the mixture being dried can be left physically undisturbed until drying is completed, it is more convenient to subject it to occasional mixing during drying, as this helps keep the individual coated proppant particles from sticking to one another, thereby minimizing particle clumping and agglomeration.

As shown in the following working examples, one way that drying can be done is by placing the mixture a conventional oven maintained at a desired elevated temperature. Under these conditions, drying will normally be complete in about 30 minutes to 24 hours, more typically about 45 minutes to 8 hours or even 1 to 4 hours. Moreover, by occasionally mixing the mass during this drying procedure, for example, once every 10 to 30 minutes or so, clumping/agglomeration of the coated proppant will be largely avoided, resulting in a free-flowing mass of proppants being produced.

Another convenient way of drying the mixture in accordance with this invention is by using a fluidized bed drier in which the mixture is fluidized by an upwardly flowing column of heated air. Fluidization causes individual coated proppant particles to separate from one another, which not only avoids clumping/agglomeration but also promotes rapid drying. Drying times as short as 15 minutes, 10 minutes or even 5 minutes or less are possible when fluidized bed driers are used.

As a result of the manufacturing procedure described above, a mass of individual, discrete starch-coated self-suspending proppants can be produced. Although some clumping and agglomeration might occur, these clumps and agglomerates can normally be broken up by mild agitation. In addition, even if clumping and agglomeration becomes more serious, application of moderate pressure such as occurs with a mortar and pestle will usually be sufficient to break up any agglomerates that have formed.

### Properties

The inventive self-suspending proppants, optionally but preferably, are free-flowing when dry. This means that any clumping or agglomeration that might occur when these proppants are stored for more than a few days can be broken up by moderate agitation. This property is beneficial in connection with storage and shipment of these proppants above ground, before they are combined with their aqueous fracturing fluids.

When deposited in their aqueous fracturing fluid, inventive self-suspending proppants hydrate to achieve an effective volumetric expansion which makes them more buoyant and hence effectively self-suspending. In addition, they retain a significant portion of this enhanced buoyancy even if they are exposed to hard or salty water. Moreover, in embodiments, they are also durable in the sense that they retain a substantial degree of their self-suspending character (i.e., their enhanced buoyancy) even after being exposed to substantial shear forces.

This enhanced buoyancy can be quantitatively determined by a Settled Bed Height Analytical Test carried out in the following manner: 35 g of the proppant is mixed with 84 ml of the aqueous liquid to be tested in a glass bottle. The bottle is shaken for 1 minute, after which bottle is left to sit undisturbed for 10 minutes to allow the contents to settle. The height of the bed formed by the hydrated, expanded proppant is then measured using a digital caliper. This bed height is then divided by the height of the bed formed by the uncoated proppant substrate particle. The number obtained indicates the factor (multiple) of the volumetric expansion.

In accordance with this invention, the inventive proppants are desirably designed to exhibit a volumetric expansion, as determined by this Settled Bed Height Analytical test when carried out using a simulated hard water containing 80,000 ppm CaCO₃, of ≧˜1.3, ≧˜1.5, ≧˜1.75, ≧˜2, ≧˜2.25, ≧˜2.5, ≧˜2.75, ≧˜3, or even ≧˜3.5.

In this regard, it will be appreciated that a volumetric expansion of 2 as determined by this test roughly corresponds to cutting the effective density of the proppant in half. For example, if an inventive self-suspending proppant made from conventional frac sand exhibits a volumetric expansion of 2 according to this test, the effective density of this frac sand will have been reduced from ˜2.65 g/cc to ˜1.4 g/cc. Persons skilled in the art will immediately recognize that this significant decrease in density will have a major positive effect on the buoyancy of the proppant obtained which, in turn, helps proppant transport in hydraulic fracturing applications tremendously, avoiding any significant proppant settlement during this time.

In terms of maximum volumetric expansion, persons skilled in the art will also recognize that there is a practical maximum to the volumetric expansion the inventive proppants can achieve, which will be determined by the particular type and amount of hydrogel-forming polymer used in each application.

Another feature of the inventive proppants is that their cationic starch coatings rapidly swell when contacted with water. In this context, “rapid swelling” will be understood to mean that at least 80% of the ultimate volume increase that these coatings will exhibit is achieved within a reasonable time after these proppants have been mixed with their aqueous fracturing liquids. Normally, this will occur within 8 to 12 minutes of the proppants being combined with their aqueous fracturing liquids, although it can also occur within 30 minutes, within 20 minutes, within 10 minutes, within 5 minutes, within 2 minutes or even within 1 minute of this time.

Still another feature of the inventive proppants is durability or shear stability. In this regard, it will be appreciated that proppants inherently experience significant shear stress when they are used, not only from pumps which charge the fracturing liquids containing these proppants downhole but also from overcoming the inherent resistance to flow encountered downhole due to friction, mechanical obstruction, sudden changes in direction, etc. The hydrogel coatings of the inventive self-suspending proppants, although inherently fragile due to their hydrogel nature, nonetheless are durable enough to resist these mechanical stresses and hence remain largely intact (or at least associated with the substrate) until they reach their ultimate use locations downhole.

For the purposes of this invention, coating durability can be measured by a Shear Analytical Test in which the settled bed height of a proppant is determined in the manner described above after a mixture of 100 g of the proppant in 1 liter of water has been subjected to shear mixing at a shear rate of about 550 s⁻¹ for a suitable period of time, for example 5 or 10 minutes. The inventive self-suspending proppants desirably exhibit a volumetric expansion, as determined by the above Settled Bed Height Test, of ≧˜1.3, more desirably ≧˜1.5, ≧˜1.6, ≧˜1.75, ≧˜2, ≧˜2.25, ≧˜2.5, ≧˜2.75, ≧˜3, or even ≧˜3.5 after being subjected to the above shearing regimen for 5 minutes using ordinary tap water as the test liquid. Inventive self-suspending proppants which exhibit volumetric expansions of ≧˜1.3, ≧˜1.5, ≧˜1.75, ≧˜2, ≧˜2.25, ≧˜2.5, ≧˜2.75 or even ≧˜3 after having been subjected to the above shearing regimen for 10 minutes using simulated hard water containing 80,000 ppm CaCO₃ or simulated salty water containing 100,000 ppm NaCl as the test liquid are especially interesting.

In addition to the above Shear Analytical Test, another means for assessing coating durability is a Viscosity Measurement Test in which the viscosity of the supernatant liquid that is produced by the above Shear Analytical Test is measured after the proppant has had a chance to settle. If the durability of a particular proppant is insufficient, an excessive amount of its hydrogel polymer coating will come off and remain dissolved or dispersed in the supernatant liquid. The extent to which the viscosity of this liquid increases as a result of this dissolved or dispersed hydrogel polymer is a measure of the durability of the hydrogel coating. A viscosity of about 20 cPs or more indicates a low coating durability. Desirably, the viscosity of the supernatant liquid will be about 10 cPs or less, more desirably about 5 cPs or less.

### WORKING EXAMPLES

In order to more thoroughly describe this invention, the following working examples are provided:

### Example 1: Cationic Starch Aqueous Dispersions

100 g of sand was added to a 250 mL glass beaker placed on a hotplate. 4 g of a 1% aqueous solution of a non-ionic surfactant (octylphenol ethoxylate) was then added to the sand and mixed for 1 to 2 minutes using an overhead mixer at 1500 rpm. 8.8 g of a commercially available cationic starch in powder form having a moisture content of about 10 wt. % and a degree of substitution of 0.0396 and containing 10 wt % amylose units and 70 to 90 wt % amylopectin was then added to 11.2 g tap water with stirring to produce 20 g of approximately 40 wt. % aqueous dispersion, which was then added to the sand followed by 0.64 g of polypropylene glycol diglycidyl ether. The mixture so obtained was then slowly heated with mixing for 3 to 4 minutes, after which 4 g of 1M NaOH was added, thereby forming a completed mixture having a water/cationic starch ratio of 2.5. Mixing was continued for an additional 1.5 minutes, by which time the temperature of the mixture had reached about 50° C. This same temperature was maintained for 15 minutes or so to allow starch gelatinization to occur and a thick gel consistency (starch viscosity of about 2,000-4,000 cPs) to be obtained. The gelled material was then transferred to an aluminum foil tray and dried in a convection oven at 120° C. for about 1 hour (or until crosslinking was complete) with mixing every 15 minutes to ensure uniform heat distribution. Drying continued for about 1 hour, thereby producing a free flowing coated proppant.

This example was repeated using a number of different commercially available cationic starches with degrees of substitution varying from 0.017 to 0.0396, amylose concentrations varying from 10 to 30 wt %, amylopectin concentrations varying from 80 to 90 wt %, and molecular weights varying from 2-6 million Daltons.

### Example 2 Cationic Starch Pastes

100 g of sand was added to a 250 mL glass beaker placed on a hotplate. 4 g of a 1% aqueous solution of a non-ionic surfactant (octylphenol ethoxylate) was then added to the sand and mixed for 1 to 2 minutes using an overhead mixer at 1500 rpm. 20 g of a commercially available cationic starch in the form of a paste was then added followed by 0.64 g of polypropylene glycol diglycidyl ether. The mixture so obtained was then slowly heated with mixing for 3 to 4 minutes, after which 4 g of 1-5 M NaOH was added, thereby forming a completed mixture having a water/cationic starch ratio of 1.8. Mixing was continued for an additional 1.5 minutes, at which time the temperature of the mixture reached about 50° C. This same temperature was maintained for an additional 15 minutes or so, until a thick gel consistency (about 3,500 cPs) was obtained. The gelled material was then transferred to an aluminum foil tray and dried in a convection oven at 120° C. with mixing every 15 minutes or so for 1 hr or until a free flowing coated proppant is obtained.

Three different runs were carried out, with the details of each run being set forth in Table 1 below:

TABLE 1
Run Details

| | Run 1 | Run 2 | Run 3 |
|---|---|---|---|
| Starch Content,wt % | 30-44 | 30-44 | 30-44 |
| Water Content, wt % | 56-70 | 56-70 | 56-70 |
| Degree of substitution | 0.2000 | 0.5500 | 0.0400 |
| Amylose, wt % | 10-20 | 10-20 | 10-20 |
| Amylopectin, wt % | 80-90 | 80-90 | 80-90 |
| Water/Starch Ratio | 2.5 | 2.5 | 3.8 |
| NaOH (M) | 5 | 1 | 5 |

### Example 3 Pretreating Sand with Crosslinking Agent

500 g of sand was added to a KitchenAid mixer. 1 g of poly(ethylene glycol) diglycidyl ether in a 5 wt % aqueous solution was then added and the mixture so obtained stirred for about 1 to 2 minutes. 100 g of a commercially available cationic starch paste containing about 40 wt. % starch and 60 wt. % water and having a viscosity of 3,000-4,000 cPs was then added. This cationic starch had a degree of substitution of about 0.55. The mixture so obtained was then mixed for an additional 3 to 4 minutes, after which 2 g of a 5M NaOH aqueous solution was added, thereby forming a completed mixture having a water/cationic starch ratio of 2.025. The mixture was then mixed while simultaneously being heated with a hot-air gun. Mixing and heating continued for 30 minutes, during which time temperature of the mixture was kept above 40° C. and below 60° C. The coated sand so obtained was then transferred into a conventional oven where it was heated at 120° C. for 4 hours until dry with stirring every 30 minutes.

The dried mixture so obtained was in the form of several large chunks, which were broken up by hand using a mortar and pestle, thereby producing a comminuted mass of free-flowing proppants.

### Example 4 Pretreating Sand with Heating

500 g of sand was pre-heated to 70° C. in conventional oven for 1 hour and then added to a KitchenAid mixer. 2 g of 10% non-ionic surfactant (octylphenol ethoxylate) was added and the mixture so obtained stirred for about 1 minute. Then, 3.2 g of poly(ethylene glycol) diglycidyl ether was added and the mixture so obtained stirred for about 30 seconds. 100 g of the same cationic starch paste as in Example 2 was then added and the mixture so obtained mixed for an additional 3 to 4 min, after which 4 g of a 5M NaOH aqueous solution was then added, thereby forming a completed mixture with a water/cationic starch ratio of 1.5. Mixing was continued for an additional 1.5 minutes. The coated sand so obtained was transferred into a conventional oven where it was heated at 120° C. for 1 hours until dry with stirring every 10 minutes. The material so obtained was in the form of chunks, which could be easily broken up with moderate pressure, thereby producing a comminuted mass of free-flowing proppants.

### Product Testing

The effective buoyancy of the inventive self-suspending proppants produced in the above Examples 1, 2 and 3 was determined by the Settled Bed Height test described above using a simulated hard water containing 80,000 ppm CaCO₃ (80 k hard water) and a settling time of 10 minutes. Each proppant showed a swelling of at least 100%, thereby demonstrating a volumetric expansion of at least 2 when measured by this test. This demonstrates that the swelling properties of the self-suspending proppants of all three working examples were largely unaffected by contact with a simulated hard water for an extended period time.

The Settled Bed Height (SBH) test of the proppant of Example 3, as described above, was continued for a total settling time of 2 hours. The volumetric expansion of the proppant produced at this time was then determined to be about 1.6, which corresponds to 60% swelling. This shows that the inventive proppant of this example continues to exhibit a high degree of self-suspending character even after very long exposure to simulated hard water.

The above Settled Bed Height test was carried out twice more on the proppant of Example 3, except that the settling time in both instances was 1 minute rather than 10 minutes. In addition, in one of these instances, the test water used contained 10 wt. % NaCl rather than 80,000 ppm CaCO₃. In both instances, the proppant demonstrated over 100% swelling, thereby demonstrating that the swelling capacity of this product remains largely unaffected by dissolved cations whether divalent or monovalent.

The durability of the inventive self-suspending proppants of the above Examples 1 and 2 were also determined by two separate tests, one using the Shear Analytical Test described above and the other using the Viscosity Measurement Test described above. In addition, the durability of a control self-suspending proppant whose hydrogel coating was made with an anionic polyacrylamide was also determined for the purpose of comparison.

In the Shear Analytical Test, two 1 L beakers were each filled with 1 L of test water. 100 g of the sample to be tested was poured into the beaker, and mixed at 275 rpm, which corresponds to a shear rate of about 550 s⁻¹. Mixing was continued for either 5 or 10 minutes, after which the mixer was turned off and the sample allowed to settle for 10 minutes. Two different test waters were used, a Standard Test Water containing 141 ppm CaCO₃ and 61 ppm KCl and a simulated hard water containing 80,000 ppm CaCO₃ (80 k hard water). After settling, the settled bed height of each expanded proppant obtained was measured in the manner indicated above.

In the Viscosity Measurement Test, the viscosities of the supernatant liquids that were produced by the above Shear Analytical Test were determined using a Fann 35 type viscometer with an R1B1 rotor-bob setup. The results obtained are shown in Table 2:

TABLE 2
Durability of Inventive Proppants

| | | 5 minute | | | |
|---|---|---|---|---|---|
| | | mixing | | 10 minute mixing | |
| | | SBH | Viscosity | SBH | Viscosity |
| Example | Test Solution | (mm) | (cP) | (mm) | (cP) |
| 1 | Standard Test | 25-35 | 2 | 25-30 | 4 |
| | Water | | | | |
| | 80k Hard | 20-30 | 2 | 20-25 | 4 |
| | Water | | | | |
| | 10% NaCl | 20-30 | 2 | 20-25 | 4 |
| 2, Run 2 | Standard Test | 25-35 | 2 | 20-25 | 4 |
| | Water | | | | |
| | 80k Hard | 20-30 | 2 | 20-25 | 4 |
| | Water | | | | |
| | 10% NaCl | 25-35 | 2-3 | 25-30 | 4 |
| 4 | 80k Hard | | | 100% swell | |
| | Water | | | | |
| Control | Standard Test | 35-45 | 2-3 | 30-35 | 3-5 |
| | Water | | | | |
| | 10% NaCl | 12-13 | 1-2 | 12-13 | 1-2 |
| | 80k Hard | 11-12 | 1-2 | 11-12 | 1-2 |
| | Water | | | | |
| Bare Sand | | 10 | 1 | 10 | 1 |

Referring first to the Control experiment, it can be seen that the control self-suspending proppant made with an anionic polyacrylamide exhibits excellent swelling compared to bare sand (Settled Bed Height of 30-45 mm vs. 10 mm) when durability tested in standard test water (low content of dissolved cations), even after being subjected to significant shear for 5 or 10 minutes. This shows that the control proppant is, indeed, durable when tested in standard test water.

Table 1 further shows that the control self-suspending proppant exhibited very little swelling compared to bare sand (SBH of 11-13 mm vs. 10 mm) when tested in simulated hard water as well as salt water containing 10 wt. % NaCl. This suggests that this proppant may exhibit limited durability when exposed to waters containing high salt concentrations.

On the other hand, the viscosity data in Table 1 shows that the viscosity of the supernatant liquids used in the above durability tests increased only slightly. This indicates that hydrogel polymer of this proppant did not come off its proppant even though subjected to high shear forces. This, in turn, suggests that this proppant retained its durability even when sheared in waters containing high salt concentrations.

Together, then, these tests appear to show that, while high salt concentrations do not adversely affect the durability of self-suspending proppants made with anionic hydrogel polymers, they do adversely affect the swelling capacity of these proppants. In other words, the data in Table 1 confirms the problem that this invention is intended to solve, i.e., that calcium and other cations ions substantially retard the ability of anionic hydrogel-forming polymers to swell when contacted with water, whether or not they have subjected to high shear.

Turning now to the data in Table 1 relating to the inventive proppants of Examples 1 and 2, this data shows that these proppants exhibit excellent swelling compared to bare sand (SBH of 20-35 mm vs. 10 mm) even when these proppants have been subjected to significant shear for 5 or 10 minutes in waters containing substantial amounts of monovalent and divalent cations. The data for Example 4 shows essentially the same. This shows that these self-suspending proppants retain a high degree of durability even when exposed to waters with high salt concentrations.

Although only a few embodiments of this invention have been described above, it should be appreciated that many modifications can be made with departing from the spirit and scope of this invention. All such modifications are intended to be included within the scope of this invention, which is to be limited only by the following claims.

1. A self-suspending proppant comprising a proppant substrate particle and a gelatinized cationic starch coating on the proppant substrate particle, wherein the self-suspending proppant exhibits a volumetric expansion as determined by its Settled Bed Height (SBH) of at least 1.5 in simulated hard water containing 80,000 ppm dissolved CaCO₃ after having been subjected to shear mixing at a shear rate of about 550 s⁻¹ for 10 minutes.

2. The self-suspending proppant of claim 1, wherein the self-suspending proppant is dry.

3. A self-suspending proppant which is both durable and especially resistant to the adverse effects of calcium and other cations on swelling, this self-suspending proppant being made by mixing proppant substrate particles with a cationic starch which is at least partially gelatinized thereby forming discrete starch-coated substrate particles, and then drying the starch-coated substrate particles so formed.

4. The self-suspending proppant of claim 3, wherein
(a) the proppant substrate particle is treated with an adhesion promoter,
(b) the cationic starch is crosslinked, or
(c) both.

5. The self-suspending proppant of claim 4, wherein the cationic starch has a degree of substitution of 0.030 to 0.55 and contains about 5 to 30 wt. % of amylose units and about 70 to 95 wt. % of amylopectin.

6. The self-suspending proppant of claim 3, wherein the cationic starch is cationic due to the presence of quaternary ammonium groups.

7. The self-suspending proppant of claim 3, wherein the self-suspending proppant exhibits a volumetric expansion by a factor of ≧˜1.3 when exposed to a simulated hard water containing 80,000 ppm CaCO₃ for 10 minutes.

8. The self-suspending proppant of claim 7, wherein the self-suspending proppant exhibits a volumetric expansion by a factor of ≧˜1.75 when exposed to a simulated hard water containing 80,000 ppm CaCO₃ for 10 minutes.

9. The self-suspending proppant of claim 8, wherein when contacted with a water-based fracturing fluid the cationic starch swells to form a hydrogel coating which has a thickness 10% to 1000% of the average diameter of the proppant particle substrate.

10. The self-suspending proppant of claim 3, wherein gelatinization of the hydrogel coating is essentially complete within about 10 minutes of being contacted with an excess of tap water at 20° C.

11. A process for making a self-suspending proppant that is especially resistant to the adverse effects of calcium and other cations on swelling, the self-suspending proppant comprising a proppant substrate particle and a gelatinized cationic starch coating on the proppant substrate particle, the process comprising chemically modifying the cationic starch, the proppant substrate particles or both to enhance coating adhesion, mixing the cationic starch with the proppant substrate particles while the starch is at least partially gelatinized thereby forming discrete starch-coated substrate particles, and then drying the starch-coated substrate particles so formed.

12. The process of claim 11, wherein chemical modification is accomplished by one or more of
(a) pretreating the proppant substrate particle with an adhesion promoter, and
(b) crosslinking the cationic starch.

13. The process of claim 12, wherein the cationic starch has a degree of substitution of 0.030 to 0.55 and contains about 5 to 30 wt. % of amylose units and about 70 to 95 wt. % of amylopectin.

14. The process of claim 11, wherein the cationic starch is cationic due to the presence of quaternary ammonium groups.

15. The process of claim 11, wherein the cationic starch is at least partially gelatinized by heating the cationic starch in the presence of water.

16. The process of claim 15, wherein the cationic starch is at least partially gelatinized by heating the cationic starch in the presence of water at a first temperature, wherein the cationic starch is combined with the proppant substrate particles either before, during or after being heated at the first temperature, and further wherein the mixture of proppant substrate particles and at least partially gelatinized cationic starch so formed is dried by heating at a second temperature which is higher than the first temperature.

17. The process of claim 16, wherein the combination of cationic starch and water which is heated at the first temperature has a water/cationic starch ratio of ≦2.5.

18. The process of claim 16, wherein the combination of cationic starch and water which is heated at the first temperature has a water/cationic starch ratio of ≦0.5.

19. The process of claim 18, wherein the combination of cationic starch and water is heated at the first temperature in an extruder.

20. The process of claim 18, wherein a cationic reagent capable of introducing cationic functionality into a starch is included in the combination of cationic starch and water which is heated at the first temperature.

21. The process of claim 20, wherein the cationic reagent is a quaternary ammonium compound including an epoxy moiety or a chlorohydrin moiety.

22. The process of claim 16, wherein the at least partially hydrolyzed cationic starch produced by heating at the first temperature is directly combined with the proppant substrate particles.

23. The process of claim 22, wherein the at least partially hydrolyzed cationic starch is produced in an extruder.

24. The process of claim 11, wherein the cationic starch is at least partially gelatinized by heating the cationic starch in the presence of water and a cationization reagent at a first temperature in an extruder, wherein the cationic starch exiting the extruder is directly combined with the proppant substrate particles, wherein the mixture so formed is mixed until starch-coated particles are formed, and further wherein the starch-coated particles so formed are dried.

25. An aqueous fracturing fluid comprising an aqueous carrier liquid and the self-suspending proppant of claim 2.

26. A method for fracturing a geological formation comprising pumping the fracturing fluid of claim 25 into the formation.
